(19) United States
(12) Patent Application Publication
(10) Pub. No.: US 2015/0352594 A1
(43) Pub. Date: Dec. 10, 2015

(54) METHOD FOR SINGLE-STEP SPRAY APPLICATOIN OF A LINER FOR SYSTEM COMPONENTS

(71) Applicant: James M. Hume, Elkton, FL (US)

(72) Inventor: James M. Hume, Elkton, FL (US)

(21) Appl. No.: 14/299,486

(22) Filed: Jun. 9, 2014

(51) Int. Cl. B05D 5/00; B05D 1/26; B05D 1/36; B05D 3/00

(52) U.S. Cl. CPC B05D 5/00; B05D 3/002; B05D 1/26; B05D 1/36

(57) ABSTRACT

A single-step, spray-applied, multi-layer liner seals the components and imparts structural integrity for lining a system component. The multi-layer liner includes an inner or first moisture barrier or skin layer, a foam layer and a second moisture barrier or skin layer. Where desired, a separate primer layer can be applied to wet surfaces and in order to form an enhanced bonding layer between the system component, typically a concrete or cement surface, and the first moisture barrier or skin layer. The first and second moisture barrier layers naturally form a skin on both sides of the internal foam layer. The combination of the foam layer and the two moisture barrier layers imparts structural strength and rigidity to the cured liner.

### BACKGROUND OF THE INVENTION

1. Field of the Invention

The invention relates generally to the rehabilitation or repair of water system and similar components, such as manholes, underground pipes or tunnels, lift stations or clarifiers utilized in the treatment of waste water and storage tanks, pumping stations and bulk storage units in the handling of clean and even potable water. The invention is directed to a multi-layer liner for lining the system components. More particularly, the invention relates to the rehabilitation of such systems where the multi-layer liner is spray-applied in a single spraying step resulting in a closed cell foam intermediate layer which is sandwiched between two hardened, impervious skin layers.

2. Discussion of the Prior Art

Deterioration of water system components and other underground systems and conduits is a severe and growing problem. For example, access manholes in many cases were originally built of brick, block or concrete construction. These components develop leaks, cracks and holes due to age, erosion, corrosion and ground water intrusion. Leakage from old manholes and sewer lines contaminates the environment and sometimes results in catastrophic damage with respect to clean-up and repair costs.

Many concrete structures, such as containment areas or ponds, require a liner to prevent leakage of the contained material into the concrete and adjacent soil and to prevent corrosion or deterioration of the concrete from the material, which is often corrosive and/or toxic. Due to the size of most of these structures, a preformed liner is both impractical and expensive. Therefore, a spray-on liner which may be applied relatively quickly, easily and at a reduced cost would be beneficial.

Since the cost of repairing the components is typically much less than the cost of replacement, many techniques have been developed in an effort to provide a suitable system for repairing and rehabilitating water system components. For example, it is known to recast manholes and the like through the use of forms and poured concrete, such as shown in U.S. Pat. No. 5,032,197 to Trimble. Because this process is very labor intensive, many techniques are directed toward spray-applied liners. For example, Strong U.S. Pat. No. 5,002,438 teaches the use of sprayed cement to form a liner inside the deteriorating structure. Spray-applied epoxy, acrylic or polyurethane liners are also known, as is the use of resin impregnated substrates, such as felt, as taught in U.S. Pat. No. 5,017,258 to Brown et al. The prior art spray-applied systems suffer from moisture, delamination, shrinkage and structural weakness problems resulting from the typical environment encountered in the repair operation.

U.S. Pat. Nos. 5,618,616 and 6,706,384 to Hume describe techniques and devices for rehabilitating water system components wherein a multilayered liner is used to impart structural strength and integrity to the components. The multilayer liner is composed of a primer layer a first moisture barrier layer, a foam layer and a second moisture barrier layer. The primer layer is applied directly to the surface of the water system components and can be applied to a wet surface. Typically, the primer layer is an epoxy material.

U.S. Pat. No. 7,279,196 to Hume describes a technique for rehabilitating water system components comprising a spray applied, multi-layer liner which seals the components and imparts structural integrity wherein the liner comprises a primer layer, a first moisture barrier layer, a foam layer and a second moisture barrier layer.

It is a principle object of this invention to provide a spray-applied liner which may be applied in a single spraying step to provide a closed-cell foam liner with hardened, impervious inner and outer skins.

It is an object of this invention to provide a technique and particular liner structure for repairing water system components which is spray-applied and does not suffer from the problems relating to moisture, delamination, shrinkage and structural weakness.

It is a further object to provide such an invention which increases the structural integrity of the repaired component due to the unique composition of the layers within the multi-layer laminate applied to the component.

It is still another object to provide such an invention which can be applied in wet conditions to any shape surface having any number of irregularities and has a rapid cure time.

### SUMMARY OF THE INVENTION

The invention is a technique and device for rehabilitating or repairing system components such as waste water or clean water systems or other underground systems, conduits, pipes or the like, comprising a spray-applied, multi-layer liner which seals the components and imparts structural integrity. The liner comprises a first moisture barrier or skin layer, a foam layer and a second moisture barrier or skin layer. Where desired, a separate primer layer can be applied to wet surfaces and in order to form an enhanced bonding layer between the system component, typically a concrete or cement surface, and the first moisture barrier or skin layer. The first and second moisture barrier layers naturally form a skin on both sides of the internal foam layer. The combination of the foam layer and the two moisture barrier layers imparts structural strength and rigidity to the cured liner. Once cured, the moisture barrier layers a polyurea and isocyanate blend, and a polyurea foam.

The subject invention is directed to a method for providing an interior lining for a structure by providing a source of closed-cell foam forming material and a source of skin forming material. The two materials are simultaneously introduced into an impingement mixing nozzle for mixing the closed-cell forming material and the skin forming material and releasing the combination under pressure toward a substrate surface. The combined materials impinge upon the surface for forming a coating thereon, wherein the coating forms an inner skin adjacent the surface and an outer skin with a closed-cell foam layer therebetween. In the preferred embodiment the closed-cell foam forming material is a polyurea, and the skin forming material is an isocyanate. Typically, the volume ratio of closed-cell foam forming material and skin forming material is approximate 1:1.

Where desired a primer layer may be applied to the substrate before applying the interior lining components. In certain applications it may also be desirable to clean the substrate before applying the interior lining components.

The method of the subject invention is suitable for use in waste water treatment systems, clean water systems and potable water systems, pipes, conduits and other underground or containment systems.

### BRIEF DESCRIPTION OF THE DRAWING

FIG. 1 is a block diagram of a system for applying the liner to a substrate.

FIG. 2 is cross-sectional perspective view of a portion of the cured multi-layer liner as applied to a substrate.

### DETAILED DESCRIPTION OF THE INVENTION

Waste water system components, such as manholes, sewer pipes, lift or pump stations, and clarifiers, degrade and deteriorate over time—resulting in loss of integrity and leakage of liquid components into the environment. Likewise, many other similar concrete or metal structures deteriorate and need to be repaired in a rapid, effective manner.

In the present invention, a multi-layer liner is spray-applied using conventional compressed air techniques to rehabilitate and repair deteriorated water systems or the like. The liner components have rapid cure rates and the cured liner imparts structural strength and integrity to the rehabilitated components.

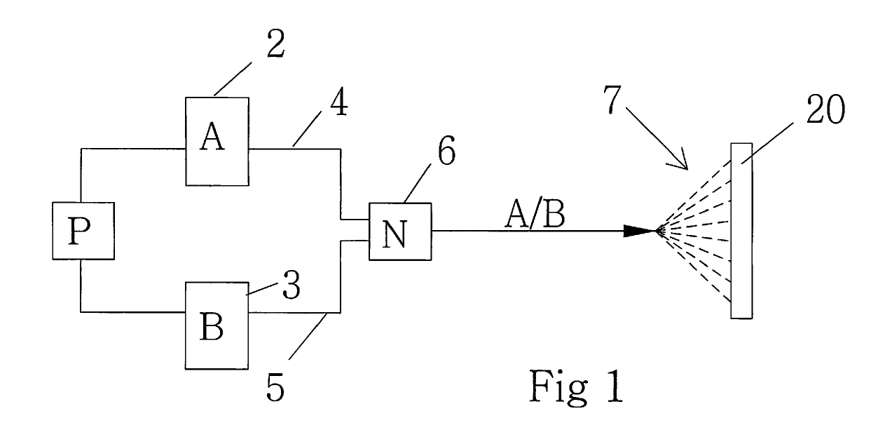

It is an important feature of the invention that the multi-layer liner may be applied in a single spray application process. Specifically, two primary components comprise the liner, an epoxy modified polyurea A and an isocyanate B. Each component is separately stored in a dedicated bulk unit, as indicated in FIG. 1. Specifically, the epoxy modified polyurea is stored in bulk in tank 2 and the isocyanate is stored in bulk in tank 3. In the preferred embodiment, the two components are adapted to be released under pressure, independently from the respective storage units, as indicated at conduits 4 and 5, respectively, and by the pressure source P The two components are provided via separate feed lines to a mixing nozzle 6.

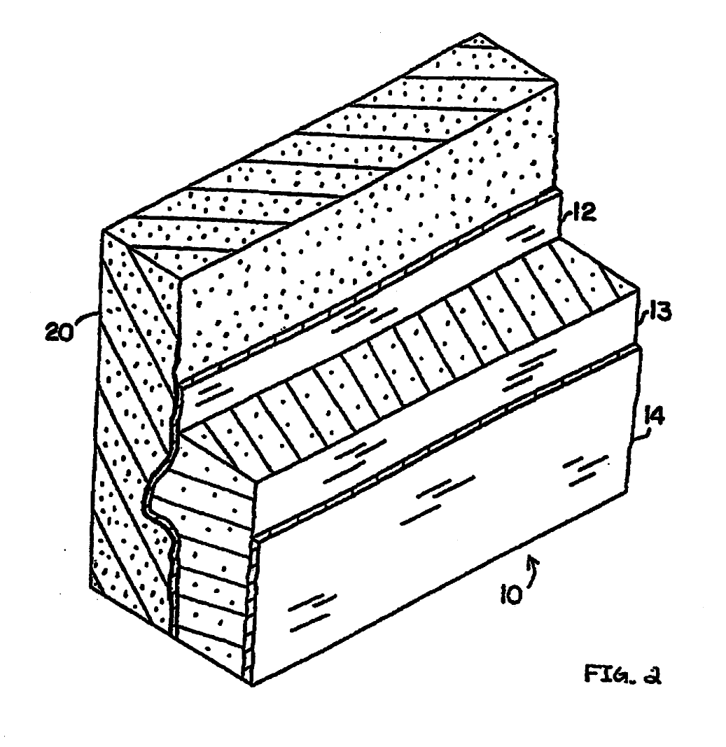

Suitable impingement mixing nozzles are commonly available from such supply sources as, by way of example, Graco, Inc., of Minneapolis, Minn. The two separate components are mixed at the nozzle and released, under pressure to a substrate 20 where they impinge on the substrate 20 as indicated at 7 and adhere to the surface and form a closed cell, self sealing foam as shown in FIG. 2

The resulting foam liner is sealed and impervious to moisture and contaminants. It provides structural integrity. The foam liner is self-priming and self-adhering and includes an integral outer layer or skin. Where desired, additional cleaning and priming of the substrate may be used, but generally this is not necessary. The skin cures to a dry state within 20 seconds to 1 minute of application, permitting the structure to be almost immediately placed back in service. Full cure is within 24 hours.

Where desired, the outer skin surface may be top coated depending on application. For example, with NSF approved urethane which is impervious to certain chemicals or paint which may be applied to increase sun resistance when applied in an exposed area.

In the preferred embodiment the volume ratio of the two components A and B is approximately 1:1 but this can be varied depending on application. Typically, each skin layer will be between 2-10 mils thick with the interior, closed cell foam layer from ½ to 1 inch in thickness. However, variations in these measurements do not deviate from the scope and spirit of the invention.

As illustrated in FIG. 2, the completed liner after application is a multi-layer liner 10 applied to a concrete, brick, block, metal or like substrate 20. Typically, the substrate 20 will be a deteriorated manhole or pipe having an irregular surface with cracks or holes, or other damaged structure. The liner 10 comprises a inner skin layer 12, which also acts as a moisture barrier layer, an intermediate foam layer 13, and a second or outer skin 14 which serves as an additional moisture barrier layer. The liner 10 is applied so as to cover the entire internal surface of the substrate 20, which is usually generally tubular or cylindrical in configuration, although any shape or configuration is possible and the technique is applicable without regard to the particular shape of the substrate 20.

The substrate 20 surface is typically prepared using high pressure water or abrasive sand blasting to remove all hard contaminants, any micro-organisms or living matter such as mold, mildew, and the like, and any loose degraded materials of the substrate itself. This abrading step results in a clean surface with an optimized surface for adhesion of the liner 20. Once this is completed, the mixed components are impinged upon the substrate from the mixing nozzle using conventional compressed air spraying devices, as described in accordance with FIG. 1. The skin layer is a material capable of adhering to the substrate 20 even if wet, and is preferably an epoxy material such as the epoxy modified polyurea as described. The spray material is coated over the entire surface to be repaired.

Preferably, a blend of a polyurea component and an isocyanate component is utilized to form the skin layers 12 and 14, with the two components formulated to have similar viscosities. The preferred polyurea and isocyanate blend has a tensile strength of greater than 1500 psi, an elongation percentage of 125%, tear strength of 350 psi, a shore D hardness of 55 and a 100% modulus of greater than 1500. The skin layers 12 and 14 are impermeable to water and other fluids and are structurally rigid. The inner skin typically adheres to the substrate 20 sufficiently to withstand pull test conditions of greater than 300 psi.

The foam layer 13 comprises a polyurea blend which rapidly foams and cures upon exiting the spray nozzle of the application equipment. Preferably, the foam material is primarily closed cell and has a rise time of less than 30 seconds and preferably less than 10 seconds. The foam layer 13 is applied preferably to result in a dry thickness of at least 500 mils, although the foam layer 13 can be thicker overall or in selected areas if necessary. The foam layer 13 preferably has a density of between 4.5 to 5.5 pounds per cubic foot, a compressive strength of between 105 to 110 psi, a closed cell content of over 90 percent, and shear strength of between 225 to 250 psi.

The resulting liner 10 is a water impermeable barrier strongly adhered to the substrate 20 which prevents liquids from leaking out of the system and also prevents ground water from entering the system. More importantly in terms of longevity, the liner 10 is a structural member which strengthens the components of the system no matter to what extent they have deteriorated. Previously used water impermeable liners, whether composed of epoxy, acrylic, polyurethane or resin impregnated substrates, are not strongly adhered to the substrate and tend to delaminate over time. These typical liners do not reinforce or impart any structural strength to the system components. The multi-layer liner 10 of the invention not only creates a liquid barrier, it adds to the strength of the system components by providing a reinforcing member which is structurally rigid due to its multi-layer composition. The liner 10 is a stressed skin panel, comprised of a structurally rigid foam internal layer 13 bounded by two adhered surface layers—first moisture barrier layer 12 and second moisture barrier layer 14—which are under stress due to the rapid cure rate of the material when applied. This rapid cure time does not allow internal stresses created by the small amount of shrinkage during curing to be relaxed, as occurs in sprayed films with long cure times. The principles of stressed skin panels, well known in the construction industry for walls of large buildings, provides for a structural member with increased structural strength and integrity of multiple factors beyond that of the individual components taken separately. Thus, the combination of the stressed skin panel created by the multi-layer combination of first moisture barrier layer 12, foam internal layer 13 and second moisture barrier layer 14 adhered to the system component results in a repaired component with exceptional structural characteristics due to the reinforcing properties of the liner 10, and is a vastly improved system over those in use today.

It is understood that obvious equivalents and substitutions may become known to those skilled in the art. The true scope and definition of the invention therefore is to be as set forth in the following claims.

What is claimed is:

1. A method for providing an interior lining for a structure, the method comprising:
comprising:
a. Providing a source of closed-cell foam forming material;
b. Providing a source of skin forming material;
c. Simultaneously introducing the closed-cell foam forming material and the skin forming material into an impingement mixing nozzle, for mixing the closed-cell forming material and the skin forming material and releasing the combination under pressure;
d. Directing the combination toward a substrate surface;
e. Permitting the combination to impinge upon the surface for forming a coating thereon, wherein the coating forms a inner skin adjacent the surface and an outer skin with a closed-cell foam layer therebetween.

2. The method of claim 1, wherein the skin forming material is an isocyanate.

3. The method of claim 1, wherein the volume ratio of closed-cell foam forming material and skin forming material is approximate 1:1.

4. The method of claim 1, further including the step of applying a primer layer to the substrate before applying the interior lining components.

5. The method of claim 1, further including the step of cleaning the substrate before applying the interior lining components.

6. A method for providing an interior lining for a structure with an interior surface designed to be in contact with water, the method comprising:
f. Providing a source of closed-cell foam forming material;
g. Providing a source of skin forming material;
h. Simultaneously introducing the closed-cell foam forming material and the skin forming material into an impingement mixing nozzle, for mixing the closed-cell forming material and the skin forming material and releasing the combination under pressure;
i. Directing the combination toward a substrate surface;
j. Permitting the combination to impinge upon the surface for forming a coating thereon, wherein the coating forms a inner skin adjacent the surface and an outer skin with a closed-cell foam layer therebetween.

7. The method of claim 6, wherein the closed-cell foam forming material is a polyurea.

8. The method of claim 6, wherein the skin forming material is an isocyanate.

9. The method of claim 6, wherein the volume ratio of closed-cell foam forming material and skin forming material is approximate 1:1.

10. The method of claim 6, further including the step of applying a primer layer to the substrate before applying the interior lining components.

11. The method of claim 6, further including the step of cleaning the substrate before applying the interior lining components.

12. The method of claim 6, wherein the substrate is the inner wall of a waste water treatment component.

13. The method of claim 6, wherein the substrate is the inner wall of a potable water system component.

14. The method of claim 1, wherein the substrate is the inner wall of a clean water system component.
